(19) United States
(12) Patent Application Publication
(10) Pub. No.: US 2007/0162272 A1
(43) Pub. Date: Jul. 12, 2007

(54) Text-processing method, program, program recording medium, and device thereof

(75) Inventor: Takafumi Koshinaka, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Minato-ku, Tokyo (JP)

(21) Appl. No.: 10/586,317

(22) PCT Filed: Jan. 17, 2005
(86) PCT No.: PCT/JP05/00461

§ 371 Date: Jul. 14, 2006

(30) Foreign Application Priority Data
Jan. 16, 2004 (JP) 2004-009144

(51) Int. Cl. G06F 17/27

(52) U.S. Cl. 704/9

(57) ABSTRACT

A temporary model generating unit (103) generates a probability model which is estimated to generate a text document as a processing target and in which information indicating which word of the text document to which topic is made to correspond to a latent variable, and each word is made to correspond to an observable variable. A model parameter estimating unit (105) estimates model parameters defining a probability model on the basis of the text document as the processing target. When a plurality of probability models are generated, a model selecting unit (107) selects an optimal probability model on the basis of the estimation result for each probability model. A text segmentation result output unit (108) segments the text document as the processing target for each topic on the basis of the estimation result on the optimal probability model. This saves the labor of adjusting parameters in accordance with the characteristics of a text document as a processing target, and eliminates the necessity to prepare a large-scale text corpus in advance by spending much time and cost. In addition, this makes it possible to accurately segment a text document as a processing target independently of the contents of the document, i.e., the domains.

### TECHNICAL FIELD

The present invention relates to a text-processing method of segmenting a text document comprising character strings or word strings for each semantic unit, i.e., each topic, a program, a program recording medium, and a device thereof.

### BACKGROUND ART

A text-processing method of this type, a program, a program recording medium, and a device thereof are used to process enormous and many text documents so as allow a user to easily obtain desired information therefrom by, for example, segmenting and classifying the text documents for each semantic content, i.e., each topic. In this case, a text document is, for example, a string of arbitrary characters or words recorded on a recording medium such as a magnetic disk. Alternatively, a text document is the result obtained by reading a character string printed on a paper sheet or handwritten on a tablet by using an optical character reader (OCR), the result obtained by causing a speech recognition device to recognize speech waveform signals generated by utterances of persons, or the like. In general, most of signal sequences generated in chronological order, e.g., records of daily weather, sales records of merchandise in a store and records of commands issued when a computer is operated, fall within the category of text documents.

Conventional techniques associated with this type of text-processing method, program, program recording medium, and device thereof are roughly classified into two types of techniques. These two types of conventional techniques will be described in detail with reference to the accompanying drawings.

According to the first conventional technique, an input text is prepared as a word sequence o₁, o₂, . . . , o_{T}, and statistics associated with word occurrence tendencies in each section in the sequence are calculated. A position where an abrupt change in statistics is seen is then detected as a point of change in topic. For example, as shown in FIG. 5, a window having a predetermined width is set for each portion of an input text, the occurrence counts of words in each window are counted, and the occurrence frequencies of the words are calculated in the form of a polynomial distribution. If a difference between two adjacent windows (windows 1 and 2 in FIG. 5) is larger than a predetermined threshold, it is determined that a change in topic has occurred at the boundary of the two windows. As a difference between two windows, for example, the KL divergence between the polynomial distributions calculated for the respective windows can be used as represented by, for example, expression (1):

$${\sum }_{i = 1}^{L} {a}_{i} log \frac{{a}_{i}}{{b}_{i}} \qquad ( 1 )$$

where aᵢ and aᵢ (i=1, . . . , L) are polynomial distributions representing the occurrence frequencies of words corresponding to windows 1 and 2, respectively, a₁+a₂+ . . . +a_{L}=1 and b₁+b₂+ . . . +b_{L}=1 hold, and L is the vocabulary size of the input text.

In the above operation, a so-called unigram is used, in which statistics in each window are calculated from the occurrence frequency of each word. However, the occurrence frequency of a concatenation of two or three adjacent words or a concatenation of an arbitrary number of words (a bigram, trigram, or n-gram) may be used. Alternatively, each word in an input text may be replaced with a real vector, and a point of change in topic can be detected in accordance with the moving amount of such a vector in consideration of the co-occurrence of non-adjacent words (i.e., simultaneous occurrence of a plurality of non-adjacent words in the same window), as disclosed in Katsuji Bessho, “Text Segmentation Using Word Conceptual Vectors”, Transactions of Information Processing Society of Japan, November 2001, Vol. 42, No. 11, pp. 2650-2662 (reference 1).

According to the second conventional technique, statistical models associated with various topics are prepared in advance, and an optimal matching between the models and an input word string is calculated, thereby obtaining a topic transition. An example of the second conventional technique is disclosed in Amaral et al., “Topic Detection in Read Documents”, Proceedings of 4th European Conference on Research and Advanced Technology for Digital Libraries, 2000 (reference 2). As shown in FIG. 6, in this example of the second conventional technique, statistical models for topics, e.g., “politics”, “sports”, and “economy”, i.e., topic models, are formed and prepared in advance. A topic model is a word occurrence frequency (unigram, bigram, or the like) obtained from text documents acquired in large amounts for each topic. If topic models are prepared in this manner and the probabilities of occurrence of transition (transition probabilities) between the topics are properly determined in advance, a topic model sequence which best matches an input word sequence can be mechanically calculated. As easily understood by replacing an input word sequence with an input speech waveform and replacing a topic model with a phoneme model, a topic transition sequence can be calculated in the manner of DP matching by using a calculation method such as frame-synchronized beam search as in many conventional techniques associated with speech recognition.

According to the above example of the second conventional technique, statistical topic models are formed upon setting topics which can be easily understood by intuition, e.g., “politics”, “sports”, and “economy”. However, as disclosed in Yamron et al., “Hidden Markov Model Approach to Text Segmentation and Event Tracking”, Proceedings of International Conference on Acoustic, Speech and Signal Processing 98, Vol. 1, pp. 333-336, 1998 (reference 3), there is also a technique of forming topic models irrelevant to human intuition by applying some kind of automatic clustering technique to text documents. In this case, since there is no need to classify in advance a large amount of text documents for each topic to form topic models, the labor required is slightly smaller than that in the above technique. This technique is however the same as that described above in that a large-scale text document set is prepared, and topic models are formed from the set.

### DISCLOSURE OF INVENTION

### Problem to be Solved by the Invention

Both the above first and second conventional techniques have a few problems.

In the first conventional technique, it is difficult to optimally adjust parameters such as a threshold associated with a difference between windows and a window width which defines a count range of word occurrence counts. In some case, a parameter value can be adjusted for desired segmentation of a given text document. For this purpose, however, time-consuming operation is required to adjust a parameter value in a trial-and-error manner. In addition, even if desired operation can be realized with respect to a given text document, it often occurs that expected operation cannot be realized when the same parameter value is applied to a different text document. For example, as a parameter like a window width is increased, the word occurrence frequencies in the window can be accurately estimated, and hence segmentation processing of a text can be accurately executed. If, however, the window width is larger than the length of a topic in the input text, the original purpose of performing topic segmentation cannot be obviously attained. That is, the optimal value of a window width varies depending on the characteristics of input texts. This also applies to a threshold associated with a difference between windows. That is, the optimal value of a threshold generally changes depending on input texts. This means that expected operation cannot be implemented depending on the characteristics of an input text document. Therefore, a serious problem arises in actual application.

In the second conventional technique, a large-scale text corpus must be prepared in advance to form topic models. In addition, it is essential that the text corpus has been segmented for each topic, and it is often required that labels (e.g., “politics”, “sports”, and “economy”) have been attached to the respective topics. Obviously, it takes much time and cost to prepare such a text corpus in advance. Furthermore, in the second conventional technique, it is necessary that the text corpus used to form topic models contain the same topics as those in an input text. That is, the domains (fields) of the text corpus need to match those of the input text. In the case of this conventional technique, therefore, if the domains of an input text are unknown or domains can frequently change, it is difficult to obtain a desired text segmentation result.

It is an object of the present invention to segment a text document for each topic at a lower cost and in a shorter time than in the prior art.

It is another object to segment a text document for each topic in accordance with the characteristics of the document independently of the domains of the document.

### Means of Solution to the Problem

In order to achieve the above objects, a text-processing method of the present invention is characterized by comprising the steps of generating a probability model in which information indicating which word of a text document belongs to which topic is made to correspond to a latent variable and each word of the text document is made to correspond to an observable variable, outputting an initial value of a model parameter which defines the generated probability model, estimating a model parameter corresponding to a text document as a processing target on the basis of the output initial value of the model parameter and the text document, and segmenting the text document as the processing target for each topic on the basis of the estimated model parameter.

In addition, a text-processing device of the present invention is characterized by comprising temporary model generating means for generating a probability model in which information indicating which word of a text document belongs to which topic is made to correspond to a latent variable and each word of the text document is made to correspond to an observable variable, model parameter initializing means for outputting an initial value of a model parameter which defines the probability model generated by the temporary model generating means, model parameter estimating means for estimating a model parameter corresponding to a text document as a processing target on the basis of the initial value of the model parameter output from the model parameter initializing means and the text document, and text segmentation result output means for segmenting the text document as the processing target for each topic on the basis of the model parameter estimated by the model parameter estimating means.

### Effects of the Invention

According to the present invention, it does not take much trouble to adjust parameters in accordance with the characteristics of a text document as a processing target, and it is not necessary to prepare a large-scale text corpus in advance by spending much time and cost. In addition, the present invention can accurately segment a text document as a processing target for each topic independently of the contents of the text document, i.e., the domains.

### BRIEF DESCRIPTION OF DRAWINGS

FIG. 1 is a block diagram showing the arrangement of a text-processing device according to an embodiment of the present invention;

FIG. 2 is a flowchart for explaining the operation of the text-processing device according to an embodiment of the present invention;

FIG. 3 is a conceptual view for explaining a hidden Markov model;

FIG. 4 is a block diagram showing the arrangement of a text-processing device according to another embodiment of the present invention;

FIG. 5 is a conceptual view for explaining the first conventional technique; and

FIG. 6 is a conceptual view for explaining the second conventional technique.

### BEST MODE FOR CARRYING OUT THE INVENTION

### FIRST EMBODIMENT

The first embodiment of the present invention will be described next in detail with reference to the accompanying drawings.

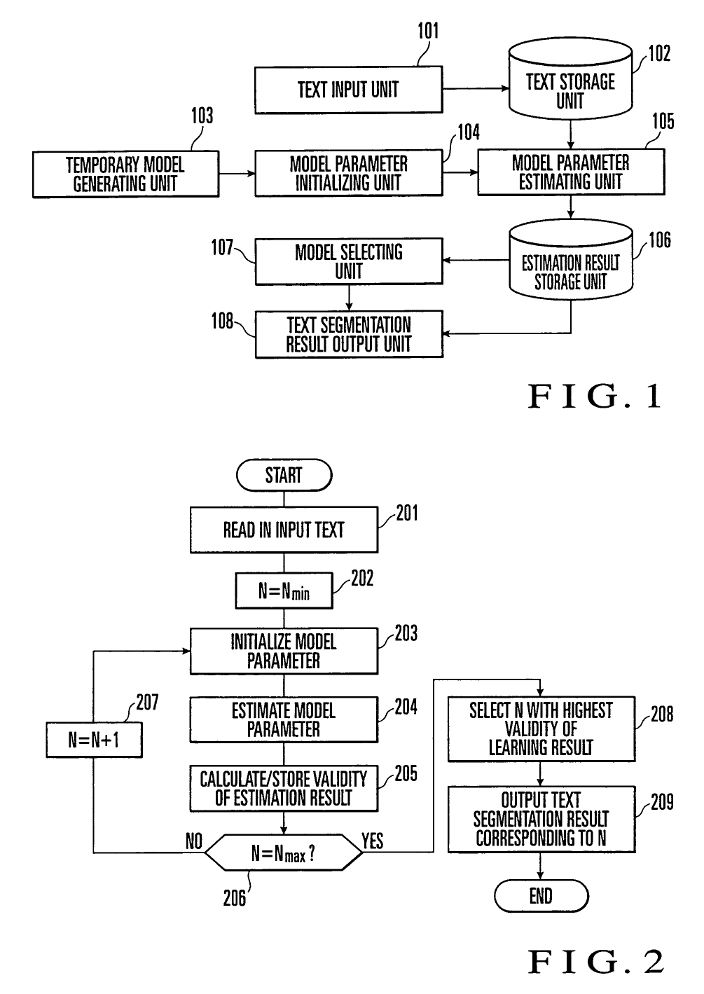

As shown in FIG. 1, a text-processing device according to this embodiment comprises a text input unit 101 which inputs a text document, a text storage unit 102 which stores the input text document, a temporary model generating unit 103 which generates one or a plurality of models each describing the transition between topics (semantic units) of the text document and in which information indicating which word of the text document belongs to which topic is made to correspond to a latent variable (a variable which cannot be observed) and each word of the text document is made to correspond to an observable variable (a variable which can be observed), a model parameter initializing unit 104 which initializes the value of each model parameter which defines each model generated by the temporary model generating unit 103, a model parameter estimating unit 105 which estimates the model parameter of the model initialized by the model parameter initializing unit 104 by using the model and the text document stored in the text storage unit 102, an estimation result storage unit 106 which stores the parameter estimation result obtained by the model parameter estimating unit 105, a model selecting unit 107 which selects a parameter estimation result on one model from parameter estimation results on a plurality of models if they are stored in the estimation result storage unit 106, and a text segmentation result output unit 108 which segments the input text document in accordance with the parameter estimation result on the model selected by the model selecting unit 107 and outputs the segmentation result. Each unit can be implemented by being operated by a program stored in a computer or by reading the program recorded on a recording medium.

In this case, as described above, a text document is a string of arbitrary characters or words recorded on a recording medium such as a magnetic disk. Alternatively, a text document is the result obtained by reading a character string printed on a paper sheet or handwritten on a tablet by using an optical character reader (OCR), the result obtained by causing a speech recognition device to recognize speech waveform signals generated by utterances of persons, or the like. In general, most of signal sequences generated in chronological order, e.g., records of daily weather, sales records of merchandise in a store and records of commands issued when a computer is operated, fall within the category of text documents.

The operation of the text-processing device according to this embodiment will be described in detail next with reference to FIG. 2.

The text document input from the text input unit 101 is stored in the text storage unit 102 (step 201). Assume that in this case, a text document is a word sequence which is a string of T words, and is represented by o₁, o₂, . . . , o_{T}. A Japanese text document, which has no space between words, may be segmented into words by applying a known morphological analysis method to the text document. Alternatively, this word string may be formed into a word string including only important words such as nouns and verbs by removing postpositional words, auxiliary verbs, and the like which are not directly associated with the topics of the text document from the word string in advance. This operation may be realized by obtaining the part of speech of each word using a known morphological analysis method and extracting nouns, verbs, adjectives, and the like as important words. In addition, if the input text document is a speech recognition result obtained by performing speech recognition of a speech signal, and the speech signal includes a silent (speech pause) section, a word like <pause> may be contained at the corresponding position of the text document. Likewise, if the input text document is a character recognition result obtained by reading a paper document with an OCR, a word like <line feed> may be contained at a corresponding position in the text document.

Note that in place of a word sequence (unigram) in a general sense, a concatenation of two adjacent words (bigram), a concatenation of three adjacent words (trigram), or a general concatenation of n adjacent words (n-gram) may be regarded as a kind of word, and a sequence of such words may be stored in the text storage unit 102. For example, the storage form of a word string comprising concatenations of two words is expressed as (o₁, o₂), (o₂, o₃), . . . , (o_{T-1}, o_{T}), and the length of the sequence is represented by T−1.

The temporary model generating unit 103 generates one or a plurality of probability models which are estimated to generate an input text document. In this case, a probability model or model is generally called a graphical model, and indicates models in general which are expressed by a plurality of nodes and arcs which connect them. Graphical models include Markov models, neural networks, Baysian networks, and the like. In this embodiment, nodes correspond to topics contained in a text. In addition, words as constituent elements of a text document correspond to observable variables which are generated from a model and observed.

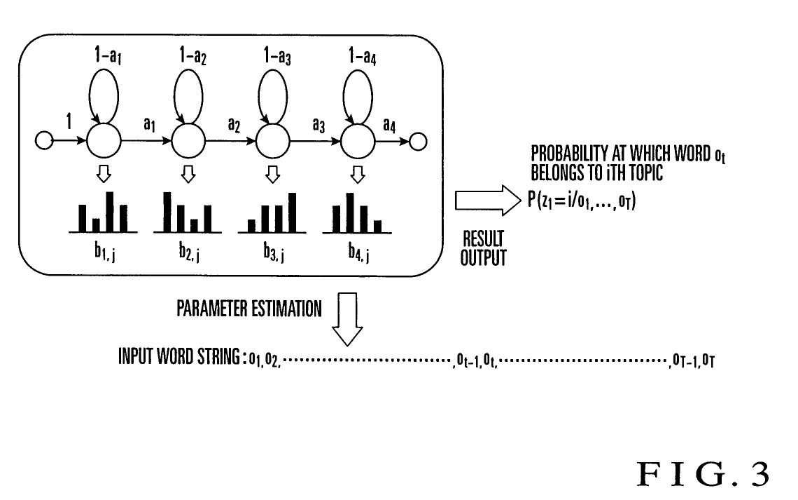

Assume that in this embodiment, a model to be used is a hidden Markov model or HMM, its structure is a one-way type (left-to-right type), and an output is a sequence of words (discrete values) contained in the above input word string. According to a left-to-right type HMM, a model structure is uniquely determined by designating the number of nodes. FIG. 3 is a conceptual view of this model. In the case of an HMM, in particular, a node is generally called a state. In the case shown in FIG. 3, the number of nodes, i.e., the number of states, is four.

The temporary model generating unit 103 determines the number of states of a model in accordance with the number of topics contained in an input text document, and generates a model, i.e., an HMM, in accordance with the number of states. If, for example, it is known that four topics are contained in an input text document, the temporary model generating unit 103 generates only one HMM with four states. If the number of topics contained in an input text document is unknown, the temporary model generating unit 103 generates one each of HMMs with all the numbers of states ranging from an HMM with a sufficiently small number Nₘᵢₙ of states to an HMM with a sufficiently larger number Nₘₐₓ of states (steps 202, 206, and 207). In this case, to generate a model means to ensure a storage area for the storage of the value of a parameter defining a model on a storage medium. A parameter defining a model will be described later.

Assume that the correspondence relationship between each topic contained in an input text document and each word of the input text document is defined as a latent variable. A latent variable is set for each word. If the number of topics is N, a latent variable can take a value from 1 to N depending on to which topic each word belongs. This latent variable represents the state of a model.

The model parameter initializing unit 104 initializes the values of parameters defining all the models generated by the temporary model generating unit 103 (step 203). Assume that in the case of the above left-to-right type discrete HMM, parameters defining the model are state transition probabilities a₁, a₂, . . . , a_{N} and signal output probabilities b_{1,j}, b_{2,j}, . . . , b_{N,j}. In this case, N represents the number of states. In addition, j=1, 2, . . . , L, and L represents the number of types of words contained in an input text document, i.e., the vocabulary size.

A state transition probability aᵢ is the probability at which a transition occurs from a state i to a state i+1, and 0<aᵢ≦1 must hold. Therefore, the probability at which the state i returns to the state i again is 1−aᵢ. A signal output probability b_{i,j} is the probability at which a word designated by an index j is output when the state i is reached after a given state transition. In all states i=1, 2, . . . , N, a signal output probability sum total b_{i,1}+b_{i,2}+ . . . b_{i,L} needs to be 1.

The model parameter initializing unit 104 sets, for example, the value of each parameter described above to aᵢ=N/T and b_{i,j}=1/L with respect to a model with a state count N. The method to be used to provide this initial value is not specifically limited, and various methods can be used as long as the above probability condition is satisfied. The method described here is merely an example.

The model parameter estimating unit 105 sequentially receives one or a plurality of models initialized by the model parameter initializing unit 104, and estimates a model parameter so as to maximize the probability, i.e., the likelihood, at which the model generates an input text document o₁, o₂, . . . , o_{T} (step 204). For this operation, a known maximum likelihood estimation method, an expectation-maximization (EM) method in particular, can be used. As disclosed in, for example, Rabiner et al., (translated by Furui et at.) “Foundation of Sound Recognition (2nd volume)”, NTT Advance Technology Corporation, November 1995, pp. 129-134 (reference 4), a forward variable αₜ(i) and a backward variable βₜ(i) are calculated throughout t=1, 2, . . . , T and i=1, 2, . . . , N by using parameter values aᵢ and b_{i,j} used at this point of time according to recurrent formulas (2). In addition, parameter values are calculated again according to formulas (3). Formulas (2) and (3) are calculated again by using the parameter values calculated again. This operation is repeated a sufficient number of times until convergence. In this case, δᵢⱼ represents a Kronecker delta. That is, if i=j, 1 is set; otherwise, 0 is set.

$$\begin{matrix}{α}_{1} ( i ) = {b}_{1 , {o}_{1}} {δ}_{1 , i} , {α}_{t} ( i ) = {a}_{t - 1} {b}_{i , {o}_{1}} {α}_{t - 1} ( i - 1 ) + ( 1 - {a}_{i} ) {b}_{i , {o}_{1}} {α}_{t - 1} ( i ) , \\ {β}_{T} ( i ) = {a}_{N} {δ}_{N , i} , {β}_{t} ( i ) = ( 1 - {a}_{i} ) {b}_{i , {o}_{t + 1}} {β}_{t + 1} ( i ) + {a}_{i} {b}_{i + 1 , {o}_{t + 1}} {β}_{t + 1} ( i + 1 ) & ( 2 ) \\ {a}_{i} ← \frac{{\sum }_{t = 1}^{T - 1} {α}_{t} ( i ) {a}_{i} {b}_{i + 1 , {o}_{t}} {β}_{t + 1} ( i + 1 )}{{\sum }_{t = 1}^{T - 1} {α}_{t} ( i ) ( 1 - {a}_{i} ) {b}_{i , {o}_{t}} {β}_{t + 1} ( i ) + {\sum }_{t = 1}^{T - 1} {α}_{t} ( i ) {a}_{i} {b}_{i + 1 , {o}_{t}} {β}_{t + 1} ( i + 1 )} , \\ {b}_{ij} ← \frac{{\sum }_{t = 1}^{T} {α}_{t} ( i ) {β}_{t} ( i ) {δ}_{i , {o}_{t}}}{{\sum }_{t = 1}^{T} {α}_{t} ( i ) {β}_{t} ( i )} & ( 3 )\end{matrix}$$

Convergence determination of iterative calculation for parameter estimation in the model parameter estimating unit 105 can be performed in accordance with the amount of increase in likelihood. That is, the iterative calculation may be terminated when there is no increase in likelihood by the above iterative calculation. In this case, a likelihood is obtained as α₁(1)β₁(1). When the iterative calculation is complete, the model parameter estimating unit 105 stores the model parameters aᵢ and b_{i,j} and the forward and backward variables αₜ(i) and βₜ(i) in the estimation result storage unit 106 in pair with the state counts of models (HMMs) (step 205).

The model selecting unit 107 receives the parameter estimation result obtained for each state count by the model parameter estimating unit 105 from the estimation result storage unit 106, calculates the likelihood of each model, and selects one model with the highest likelihood (step 208). The likelihood of each model can be calculated on the basis of a known AIC (Akaike's Information Criterion), an MDL (Minimum Description Length) criterion, or the like. Information about an Akaike's information criterion and minimum description length criterion is described in, for example, Te Sun Han et al., “Applied Mathematics II of the Iwanami Lecture, Mathematics of Information and Coding”, Iwanami Shoten, December 1994, pp. 249-275 (reference 5). For example, according to an AIC, a model exhibiting the largest difference between a logarithmic likelihood log(α₁(1)β₁(1)) after parameter estimation convergence and a model parameter count NL is selected. In addition, according to an MDL, a selected model is a model whose sum of −log(α₁(1)β₁(1)) obtained by sign-reversing a logarithmic likelihood and a product NL×log(T)/2 of a model parameter count and the square root of the word sequence length of an input text document becomes approximately minimum. In the case of both an AIC and an MDL, in general, a selected model is intentionally adjusted by multiplying a term associated with the model parameter count NL by an empirically determined constant coefficient. It suffices to also perform such operation in this embodiment.

The text segmentation result output unit 108 receives a model parameter estimation result corresponding to a model with the state count N which is selected by the model selecting unit 107 from the estimation result storage unit 106, and calculates a segmentation result for each topic for the input text document in the estimation result (step 209).

By using the model with the state count N, the input text document o₁, o₂, . . . , o_{T} is segmented into N sections. The segmentation result is probabilistically calculated first according to equation (4). Equation (4) indicates the probability at which a word ot in the input text document is assigned to the ith topic section. The final segmentation result is obtained by obtaining i with which P(zₜ=i|o₁, o₂, . . . , o_{T}) is maximized throughout t=1, 2, . . . , T.

$$P ( {z}_{t} = i \vert {o}_{1} , {o}_{2} , … , {o}_{T} ) = \frac{{α}_{t} ( i ) {β}_{t} ( i )}{{\sum }_{j = 1}^{N} {α}_{t} ( j ) {β}_{t} ( j )} \qquad ( 4 )$$

In this case, the model parameter estimating unit 105 sequentially updates the parameters by using the maximum likelihood estimation method, i.e., formulas (3). However, MAP (Maximum A Posteriori) estimation can also be used instead of the maximum likelihood estimation method. Information about maximum a posteriori estimation is described in, for example, Rabiner et al., (translated by Furui et at.) “Foundation of Sound Recognition (2nd volume)”, NTT Advance Technology Corporation, November 1995, pp. 166-169 (reference 6). In the case of maximum a posteriori estimation, if, for example, conjugate prior distributions are used as the prior distributions of model parameters, the prior distribution of aᵢ is expressed as beta distribution log p(aᵢ|, κ₀κ₁)=(κ₀−1)×log(1−aᵢ)+(κ₁−1)×log(aᵢ)+const, and the distribution of bᵢⱼ is expressed as direct distribution log p(b_{i,1}, b_{i,2}, . . . , b_{i,L}|λ₁, λ₂, . . . , λ_{L})=(λ₁−1)×log(b_{i,1})+(λ₂−1)×log(b_{i,2})+ . . . +(λ_{L}−1)×log(b_{i,L})+const, where κ₀, κ₁, λ₁, λ₂, . . . , λ_{L} and const are constants. At this time, parameter updating formulas for maximum a posteriori estimation corresponding to formulas (3) for maximum likelihood estimation are expressed as:

$${a}_{i} ← \frac{{\sum }_{t = 1}^{T - 1} {α}_{t} ( i ) {a}_{i} {b}_{i + 1 , {o}_{t}} {β}_{t + 1} ( i + 1 ) + {κ}_{1} - 1}{\begin{matrix}{\sum }_{t = 1}^{T - 1} {α}_{t} ( i ) ( 1 - {a}_{i} ) {b}_{i , {o}_{t}} {β}_{t + 1} ( i ) {κ}_{0} - 1 + \\ {\sum }_{t = 1}^{T - 1} {α}_{t} ( i ) {a}_{i} {b}_{i + 1 , {o}_{t}} {β}_{t + 1} ( i + 1 ) + {κ}_{2} - 1\end{matrix}} , \\ {b}_{ij} ← \frac{{\sum }_{t = 1}^{T} {α}_{t} ( i ) {β}_{t} ( i ) {δ}_{j , {o}_{t}} + {λ}_{i} - 1}{{\sum }_{t = 1}^{T} {α}_{t} ( i ) {β}_{t} ( i ) + {\sum }_{k = 1}^{L} ( {λ}_{k} - 1 )} \qquad ( 5 )$$

In this embodiment described so far, the signal output probability bᵢⱼ is made to correspond to a state. That is, the embodiment uses a model in which a word is generated from each state (node) of an HMM. However, the embodiment can use a model in which a word is generated from a state transition (arm). A model in which a word is generated from a state transition is useful for a case wherein, for example, an input text is an OCR result on a paper document or a speech recognition result on a speech signal. This is because, in the case of a text document containing a speech pause in a speech signal or a word indicating a line feed in a paper document, i.e., <pause> or <line feed>, if a signal output probability is fixed such that a word generated from a state transition from the state i to the state i+1 is always <pause> or <line feed>, <pause> or <line feed> can always be made to correspond to a topic boundary detected from the input text document by this embodiment. Assume that the input text document is not an OCR result or speech recognition result. Even in this case, if a signal output probability is set in advance such that a word closely associated with a topic change such as “then”, “next”, “well”, or the like is generated from a state transition from the state i to the state i+1 in a model in which a word is generated from a state transition, a word like “then”, “next”, or “well” can be made to easily appear at a detected topic boundary.

### SECOND EMBODIMENT

The second embodiment of the present invention will be described in detail next with reference to the accompanying drawings.

This embodiment is shown in the block diagram of FIG. 1 like the first embodiment. That is, this embodiment comprises a text input unit 101 which inputs a text document, a text storage unit 102 which stores the input text document, a temporary model generating unit 103 which generates one or a plurality of models each describing the transition between topics of the text document and in which information indicating which word of the text document belongs to which topic is made to correspond to a latent variable and each word of the text document is made to correspond to an observable variable, a model parameter initializing unit 104 which initializes the value of each model parameter which defines each model generated by the temporary model generating unit 103, a model parameter estimating unit 105 which estimates the model parameter of the model initialized by the model parameter initializing unit 104 by using the model and the text document stored in the text storage unit 102, an estimation result storage unit 106 which stores the parameter estimation result obtained by the model parameter estimating unit 105, a model selecting unit 107 which selects a parameter estimation result on one model from parameter estimation results on a plurality of models if they are stored in the estimation result storage unit 106, and a text segmentation result output unit 108 which segments the input text document in accordance with the parameter estimation result on the model selected by the model selecting unit 107 and outputs the segmentation result. Each unit can be implemented by being operated by a program stored in a computer or by reading the program recorded on a recording medium.

The operation of this embodiment will be sequentially described next.

The text input unit 101, text storage unit 102, and temporary model generating unit 103 respectively perform the same operations as those of the text input unit 101, text storage unit 102, and temporary model generating unit 103 of the first embodiment described above. As in the first embodiment, the text storage unit 102 stores an input text document as a string of words, a string of concatenations of two or three adjacent words, or a general string of concatenations of n words, and an input text document which is written in Japanese having no spaces between words can be handled as a word string by applying a known morphological analysis method to the document.

The model parameter initializing unit 104 initializes the values of parameters defining all the models generated by the temporary model generating unit 103. Assume that each model is a left-to-right type discrete HMM as in the first embodiment, and is further defined as a tied-mixture HMM. That is, a signal output from a state i is linear combination c_{i,1}b_{1,j}+c_{i,2}b_{2,j}+ . . . c_{i,M}b_{M,j} of M signal output probabilities b_{1,j}, b_{2,j}, . . . , b_{M,j}, and the value of b_{i,j} is common to all states. In general, M represents an arbitrary natural number smaller than a state count N. Information about a tied-mixture HMM is described in, for example, Rabiner et al., (translated by Furui et at.) “Foundation of Sound Recognition (2nd volume)”, NTT Advance Technology Corporation, November 1995, pp. 280-281 (reference 7). The model parameters of a tied-mixture HMM include a state transition probability aᵢ, a signal output probability b_{j,k} common to all states, and a weighting coefficient c_{i,j} for the signal output probability. In this case, i=1, 2, . . . , N, where N is a state count, j=1, 2, . . . , M, where M is the number of types of topics, and k=1, 2, . . . , L, where L is the number of types of words, i.e., the vocabulary size, contained in an input text document. The state transition probability aᵢ is the probability at which a transition occurs from a state i to a state i+1 as in the first embodiment. The signal output probability b_{i,j} is the probability at which a word designated by an index k is output in a topic j. The weighting coefficient c_{i,j} is the probability at which the topic j occurs in the state i. As in the first embodiment, the sum total b_{j,1}+b_{j,2}+ . . . +b_{j,L} of signal output probabilities needs to be 1, and sum total c_{i,1}+c_{i,2}+ . . . c_{i,L} of weighting coefficients needs to be 1.

The model parameter initializing unit 104 sets, for example, the value of each parameter described above to aᵢ=N/T, b_{j,k}=1/L, and c_{i,j}=1/M with respect to a model with a state count N. The method to be used to provide this initial value is not specifically limited, and various methods can be used as long as the above probability condition is satisfied. The method described here is merely an example.

The model parameter estimating unit 105 sequentially receives one or a plurality of models initialized by the model parameter initializing unit 104, and estimates a model parameter so as to maximize the probability, i.e., the likelihood, at which the model generates an input text document o₁, o₂, . . . , o_{T}. For this operation, an expectation-maximization (EM) method can be used as in the first embodiment. A forward variable αₜ(i) and a backward variable βₜ(i) are calculated throughout t=1, 2, . . . , T and i=1, 2, . . . , N by using parameter values aᵢ, b_{j,k}, and c_{i,j} used at this point of time according to recurrent formulas (6). In addition, parameter values are calculated again according to formulas (7). Formulas (6) and (7) are calculated again by using the parameter values calculated again. This operation is repeated a sufficient number of times until convergence. In this case, δᵢⱼ represents a Kronecker delta. That is, if i=j, 1 is set; otherwise, 0 is set.

$$\begin{matrix}{α}_{1} ( i ) = {\sum }_{j = 1}^{M} {c}_{1 , j} {b}_{j , {o}_{1}} {δ}_{1 , j} , {α}_{t} ( i ) = {\sum }_{j = 1}^{M} \{ \begin{matrix}{a}_{i - 1} , {c}_{i , j} {b}_{j , {o}_{t}} {α}_{t - 1} ( i - 1 ) + \\ ( 1 - {a}_{i} ) {c}_{i , j} {b}_{j , {o}_{i}} {α}_{t - 1} ( i )\end{matrix} \} , \\ {β}_{1} ( i ) = {a}_{N} {δ}_{N , j} , {β}_{t} ( i ) = {\sum }_{j = 1}^{M} \{ \begin{matrix}( 1 - {a}_{i} ) {c}_{i , j} {b}_{j , {o}_{t + 1}} {β}_{t + 1} ( i ) + \\ {a}_{i} {c}_{i + 1 , j} {b}_{j , {o}_{t + 1}} {β}_{t + 1} ( i + 1 )\end{matrix} \} & ( 6 ) \\ {a}_{i} ← \frac{{\sum }_{t = 1}^{T - 1} {\sum }_{j = 1}^{M} {α}_{t} ( i ) {a}_{i} {c}_{i + 1 , j} {b}_{j , {o}_{t}} {β}_{t + 1} ( i + 1 )}{{\sum }_{t = 1}^{T - 1} {\sum }_{j = 1}^{M} \{ \begin{matrix}{a}_{t} ( i ) ( 1 - {a}_{i} ) {c}_{i , j} {b}_{j , {o}_{t}} {β}_{t + 1} ( i ) + \\ {α}_{t} ( i ) {a}_{i} {c}_{i + 1 , j} {b}_{j , {o}_{t}} {β}_{t + 1} ( i + 1 )\end{matrix}} , \\ {b}_{ij} ← \frac{{\sum }_{t = 1}^{T} {\sum }_{i = 1}^{N} \{ \begin{matrix}{α}_{t} ( i ) ( 1 - {a}_{i} ) {c}_{i , j} {b}_{j , {o}_{t}} {β}_{t + 1} ( i ) + \\ {α}_{t} ( i ) {a}_{i} {c}_{i + 1 , j} {b}_{j , {o}_{t}} {β}_{t + 1} ( i + 1 )\end{matrix} \}}{{\sum }_{t = 1}^{T} {\sum }_{i = 1}^{N} {\sum }_{k = 1}^{L} \{ \begin{matrix}{α}_{t} ( {i}^{′} ) ( 1 - {a}_{{i}^{′}} ) {c}_{{i}^{′} , j} {b}_{j , k} {β}_{t + 1} ( {i}^{′} ) + \\ {α}_{t} ( {i}^{′} ) {a}_{i} , {c}_{{i}^{′} + 1 , j} {b}_{j , k} {β}_{t + 1} ( {i}^{′} + 1 )\end{matrix} \}} , \\ {c}_{ij} ← \frac{{\sum }_{t = 1}^{T} \{ {α}_{t} ( i ) ( 1 - {a}_{i} ) {c}_{i , j} {b}_{j , {o}_{t}} {β}_{t + 1} ( i ) + {α}_{t} ( i ) {a}_{i} {c}_{i + 1 , j} {b}_{j , {o}_{t}} {β}_{t + 1} ( i + 1 ) \}}{{\sum }_{{j}^{′} = 1}^{M} {\sum }_{t = 1}^{T} \{ \begin{matrix}{α}_{t} ( i ) ( 1 - {a}_{i} ) {c}_{i , {j}^{′}} {b}_{{j}^{′} , {o}_{t}} {β}_{t + 1} ( i ) + \\ {α}_{t} ( i ) {a}_{i} {c}_{i + 1 , {j}^{′}} {b}_{{j}^{′} , {o}_{t}} {β}_{t + 1} ( i + 1 )\end{matrix} \}} & ( 7 )\end{matrix}$$

Convergence determination of iterative calculation for parameter estimation in the model parameter estimating unit 105 can be performed in accordance with the amount of increase in likelihood. That is, the iterative calculation may be terminated when there is no increase in likelihood by the above iterative calculation. In this case, a likelihood is obtained as α₁(1)β₁(1). When the iterative calculation is complete, the model parameter estimating unit 105 stores the model parameters aᵢ, b_{j,k}, and c_{i,j} and the forward and backward variables αₜ(i) and βₜ(i) in the estimation result storage unit 106 in pair with the state counts of models (HMMs).

The model selecting unit 107 receives the parameter estimation result obtained for each state count by the model parameter estimating unit 105 from the estimation result storage unit 106, calculates the likelihood of each model, and selects one model with the highest likelihood. The likelihood of each model can be calculated on the basis of a known AIC (Akaike's Information Criterion), MDL (Minimum Description Length) criterion, or the like.

In the case of both an AIC and an MDL, as in the first embodiment, a selected model is intentionally adjusted by multiplying a term associated with the model parameter count NL by an empirically determined constant coefficient.

Like the text segmentation result output unit 108 in the first embodiment, the text segmentation result output unit 108 receives a model parameter estimation result corresponding to a model with the state count N which is selected by the model selecting unit 107 from the estimation result storage unit 106, and calculates a segmentation result for each topic for the input text document in the estimation result. A final segmentation result can be obtained by obtaining i, throughout t=1, 2, . . . , T, with which P(zₜ=i|o₁, o₂, . . . , o_{T}) is maximized, according to equation (4).

Note that, as in the first embodiment, the model parameter estimating unit 105 may estimate model parameters by using the MAP (Maximum A Posteriori) estimation method instead of the maximum likelihood estimation method.

### THIRD EMBODIMENT

The third embodiment of the present invention will be described next with reference to the accompanying drawings.

This embodiment is shown in the block diagram of FIG. 1 like the first and second embodiments. That is, this embodiment comprises a text input unit 101 which inputs a text document, a text storage unit 102 which stores the input text document, a temporary model generating unit 103 which generates one or a plurality of models each describing the transition between topics of the text document and in which information indicating which word of the text document belongs to which topic is made to correspond to a latent variable and each word of the text document is made to correspond to an observable variable, a model parameter initializing unit 104 which initializes the value of each model parameter which defines each model generated by the temporary model generating unit 103, a model parameter estimating unit 105 which estimates the model parameter of the model initialized by the model parameter initializing unit 104 by using the model and the text document stored in the text storage unit 102, an estimation result storage unit 106 which stores the parameter estimation result obtained by the model parameter estimating unit 105, a model selecting unit 107 which selects a parameter estimation result on one model from parameter estimation results on a plurality of models if they are stored in the estimation result storage unit 106, and a text segmentation result output unit 108 which segments the input text document in accordance with the parameter estimation result on the model selected by the model selecting unit 107 and outputs the segmentation result. Each unit can be implemented by being operated by a program stored in a computer or by reading the program recorded on a recording medium.

The operation of this embodiment will be sequentially described next.

The text input unit 101, text storage unit 102, and temporary model generating unit 103 respectively perform the same operations as those of the text input unit 101, text storage unit 102, and temporary model generating unit 103 of the first and second embodiments described above. As in the same manner in the first and second embodiments of the present invention, the text storage unit 102 stores an input text document as a string of words, a string of concatenations of two or three adjacent words, or a general string of concatenations of n words, and an input text document which is written in Japanese having no spaces between words can be handled as a word string by applying a known morphological analysis method to the document.

The model parameter initializing unit 104 hypothesizes kinds of distributions by using model parameters, i.e., a state transition probability aᵢ and a signal output probability bᵢⱼ as probability variables with respect to one or a plurality of models generated by the temporary model generating unit 103, and initializes the values of the parameters defining the distributions. Parameters which define the distributions of model parameters will be referred to as hyper-parameters with respect to original parameters. That is, the model parameter initializing unit 104 initializes hyper-parameters. In this embodiment, as the distributions of state transition probabilities aᵢ and signal output probabilities bᵢⱼ, the following are used respectively: beta distribution log p(aᵢ|κ_{0,i}, κ_{1,i})=(κ_{0,i}−1)×log(1−aᵢ)+(κ_{1,i}−1)×log(aᵢ)+const and direct distribution log p(b_{i,1}, b_{i,2}, . . . , b_{i,L}|λ_{i,1}, λ_{i,2}, . . . , λ_{i,L})=(λ_{i,1}−1)×log(b_{i,1})+(λ_{i,2}−1)×log(b_{i,2})+ . . . +(λ_{i,L}−1)×log(b_{i,L})+const. The hyper-parameters are κ_{0,1}, κ_{1,i}, and λ_{i,j}. In this case, i=1, 2, . . . , N and j=1, 2, . . . , L. The model parameter initializing unit 104 initializes hyper-parameters, for example, according to κ_{0,i}=κ₀, κ_{1,i}=κ₁, and λᵢⱼ=λ₀ for κ₀=ε(1−N/T)+1, κ₁=εN/T+1, and λ₀=ε/L+1. A proper positive number like 0.01 is assigned to ε. Note that the method to be used to provide this initial value is not specifically limited, and various methods can be used. This initialization method is merely an example.

The model parameter estimating unit 105 sequentially receives one or a plurality of models initialized by the model parameter initializing unit 104, and estimates hyper-parameters so as to maximize the probability, i.e., the likelihood, at which the model generates the input text document o₁, o₂, . . . , o_{T}. For this operation, a known variational Bayes method derived from the Bayes estimation method can be used. For example, as described in Ueda, “Bayes Learning [III]—Foundation of Variational Bayes Learning”, THE TRANSACTIONS OF THE INSTITUTE OF ELECTRONICS, INFORMATION AND COMMUNICATION ENGINEERS, July 2002, Vol 85, No. 7, pp. 504-509 (reference 8), a forward variable αₜ(i) and a backward variable βₜ(i) are calculated throughout t=1, 2, . . . , T and i=1, 2, . . . , N by using hyper-parameter values κ_{0,i}, κ_{1,i}, and λ_{i,j} obtained at this point of time, and hyper-parameter values are further calculated again according to formula (9). Formulas (8) and (9) are calculated again by using the parameter values calculated again. This operation is repeated a sufficient number of times until convergence. In this case, δᵢⱼ represents a Kronecker delta. That is, if i=j, 1 is set; otherwise, 0 is set. In addition, Ψ(x)=d(log Γ(x))/dx, and Γ(x) is a gamma function.

$$\begin{matrix}\begin{matrix}{α}_{1} ( i ) = exp ( {B}_{i , {o}_{t}} ) {δ}_{1 , i} , \\ {α}_{t} ( i ) = {α}_{t - 1} ( i - 1 ) exp ( {A}_{1 , i - 1} + {B}_{i , {o}_{t}} ) {α}_{t - 1} ( i ) exp ( {A}_{0 , i} + {B}_{i , {o}_{t}} ) , \\ {β}_{T} ( i ) = exp ( {A}_{1 , N} ) {δ}_{N , i} , \\ {β}_{t} ( i ) = {β}_{t + 1} ( i ) exp ( {A}_{0 , i} + {B}_{i , {o}_{t + 1}} ) + {β}_{t + 1} ( i + 1 ) exp ( {A}_{1 , i} + {B}_{i + 1 , {o}_{t + 1}} )\end{matrix} \\ for & ( 8 ) \\ \begin{matrix}{A}_{0 , i} = Ψ ( {κ}_{0 , i} ) - Ψ ( {κ}_{0 , i} + {κ}_{1 , i} ) , \\ {A}_{1 , i} = Ψ ( {κ}_{1 , i} ) - Ψ ( {κ}_{0 , i} + {κ}_{1 , i} ) , \\ {B}_{ik} = Ψ ( {λ}_{ik} ) - Ψ ( {\sum }_{j = 1}^{L} {λ}_{ij} )\end{matrix} \\ {κ}_{0 , i} ← {κ}_{0} + {\sum }_{t = 1}^{T - 1} \overline{{z}_{t , i} {z}_{t + 1 , i} ,} \\ {κ}_{1 , i} ← {κ}_{1} + {\sum }_{t = 1}^{T + 1} \overline{{z}_{t , i} {z}_{t + 1 , i + 1} ,} + {δ}_{N , i} , \\ {λ}_{ik} ← {λ}_{0} + {\sum }_{t = 1}^{T - 1} \overline{{z}_{t , i} {δ}_{k , {o}_{t}}} \\ for \\ \overline{{z}_{t , i}} = \frac{{α}_{t} ( i ) {β}_{t} ( i )}{{\sum }_{j = 1}^{N} {α}_{i} ( j ) {β}_{t} ( j )} , \\ \overline{{z}_{t , i} {z}_{t + 1 , i}} = \frac{{α}_{t} ( i ) exp ( {A}_{0 , i} + {B}_{i , {0}_{t + 1}} ) {β}_{t + 1} ( i )}{{\sum }_{j = 1}^{N} {\sum }_{s = \{ 0 , 1 \}} {α}_{t} ( j ) exp ( {A}_{s , j} + {B}_{j + s , {o}_{t + 1}} ) {β}_{t + 1} ( j + s )} , \\ \overline{{z}_{t , i} {z}_{t + 1 , i + 1}} = \frac{{α}_{t} ( i ) exp ( {A}_{1 , i} + {B}_{i + 1 , {o}_{t + 1}} ) {β}_{t + 1} ( i + 1 )}{{\sum }_{j = 1}^{N} {\sum }_{s = \{ 0 , 1 \}} {α}_{t} ( j ) exp ( {A}_{s , j} + {B}_{j + s , {o}_{t + 1}} ) {β}_{t + 1} ( j + s )} & ( 9 )\end{matrix}$$

Convergence determination of iterative calculation for parameter estimation in the model parameter estimating unit 105 can be performed in accordance with the amount of increase in approximate likelihood. That is, the iterative calculation may be terminated when there is no increase in approximate likelihood by the above iterative calculation. In this case, an approximate likelihood is obtained as product α₁(1)β₁(1) of forward and backward variables. When the iterative calculation is complete, the model parameter estimating unit 105 stores the hyper-parameters κ_{0,i}, κ_{1,i}, and λ_{i,j} and the forward and backward variables αₜ(i) and βₜ(i) in the estimation result storage unit 106 in pair with the state counts N of models (HMMs).

Note that as a Bayes estimation method in the model parameter estimating unit 105, an arbitrary method such as a known Markov chain Monte Carlo method or Laplace approximation method other than the above variational Bayes method can be used. This embodiment is not limited to the variational Bayes method.

The model selecting unit 107 receives the parameter estimation result obtained for each state count by the model parameter estimating unit 105 from the estimation result storage unit 106, calculates the likelihood of each model, and selects one model with the highest likelihood. As the likelihood of each model, a known Bayesian criterion (Bayes posteriori probability) can be used within the frame of the above variational Bayes method. A Bayesian criterion can be calculated by formula (10). In formula (10), P(N) is the priori probability of a state count, i.e., a topic count N, which is determined in advance by some kind of method. If there is no specific reason, P(N) may be a constant value. In contrast, if it is known in advance that a specific state count is likely to occur or not likely to occur, P(N) corresponding to the specific state count is set to a large or small value. In addition, as the hyper-parameters κ_{0,i}, κ_{1,i}, and λ_{i,j} and the forward and backward variables α₁(i) and β₁(i), values corresponding to the state count N are acquired from the estimation result storage unit 106 and used.

$$P ( N ) {α}_{1} ( 1 ) {β}_{1} ( 1 ) \\ x exp \{ \begin{matrix}{\sum }_{i = 1}^{N} ( {κ}_{0 , i} - {κ}_{0} ) ( Ψ ( {κ}_{0 , i} + {κ}_{1 , i} ) - Ψ ( {κ}_{0 , i} ) ) + \\ {\sum }_{i = 1}^{N} ( {κ}_{1 , i} - {κ}_{1} ) ( Ψ ( {κ}_{0 , i} + {κ}_{1 , i} ) - Ψ ( {κ}_{1 , i} ) )\end{matrix} \} \\ x exp \{ {\sum }_{i = 1}^{N} {\sum }_{k = 1}^{L} ( {λ}_{ij} - {λ}_{0} ) ( Ψ ( {\sum }_{j = 1}^{L} {λ}_{ij} ) - Ψ ( {λ}_{ik} ) ) \} \\ x {\prod }_{i = 1}^{N} \{ \frac{Γ ( {κ}_{0} + {κ}_{1} ) Γ ( {κ}_{0 , i} ) Γ ( {κ}_{1 , i} ) Γ ( {\sum }_{j = 1}^{L} {λ}_{0} )}{Γ ( {κ}_{0 , i} + {κ}_{1 , i} ) Γ ( {κ}_{0} ) Γ ( {κ}_{1} ) Γ ( {\sum }_{j = 1}^{L} {λ}_{i , j} )} {\prod }_{j = 1}^{L} \frac{Γ ( {λ}_{ij} )}{Γ ( {λ}_{0} )} \} \qquad ( 10 )$$

Like the text segmentation result output unit 108 in the first and second embodiments described above, the text segmentation result output unit 108 receives a model parameter estimation result corresponding to a model with the state count, i.e., the topic count N, which is selected by the model selecting unit 107 from the estimation result storage unit 106, and calculates a segmentation result for each topic for the input text document in the estimation result. A final segmentation result can be obtained by obtaining i, throughout t=1, 2, . . . , T, with which P(zₜ=i|o₁, o₂, . . . , o_{T}) is maximized, according to equation (4).

Note that in this embodiment, as in the second embodiment described above, the temporary model generating unit 103, model parameter initializing unit 104, and model parameter estimating unit 105 can be each configured to generate a tied-mixture left-to-right type HMM, instead of a general left-to-right type HMM, initialize, and perform parameter estimation.

### FOURTH EMBODIMENT

The fourth embodiment of the present invention will be described in detail next with reference to the accompanying drawings.

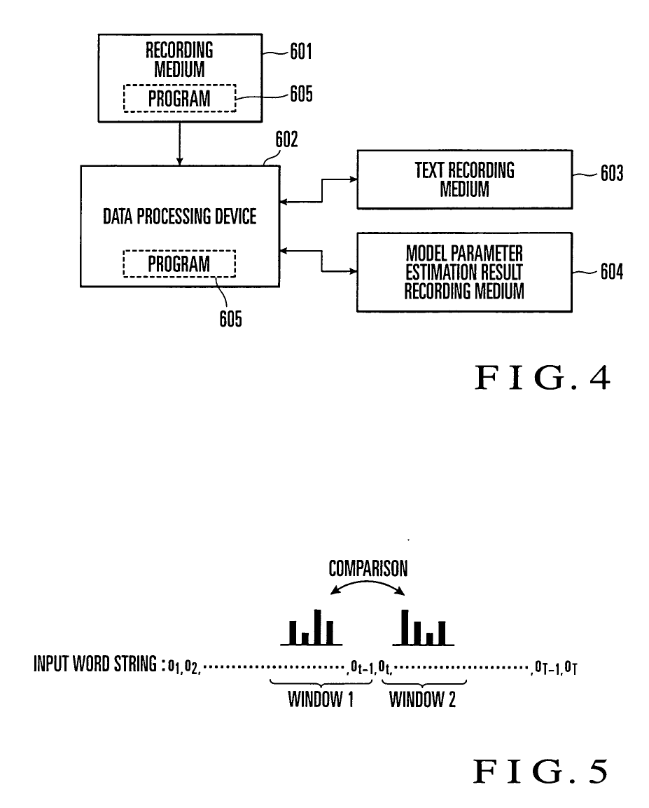

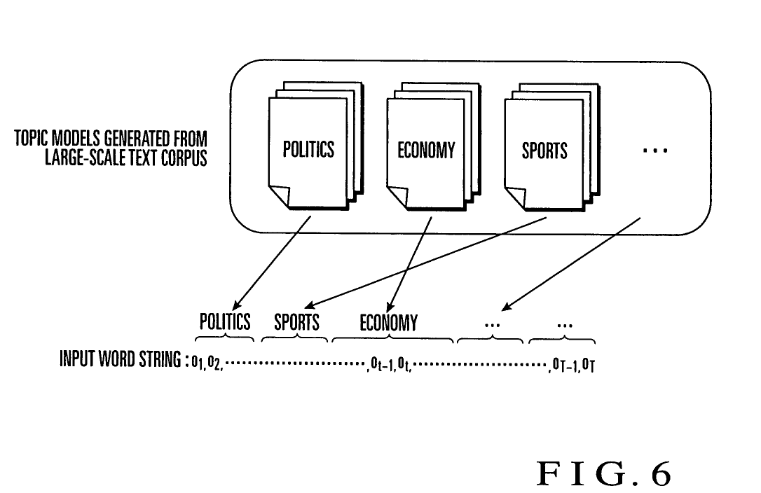

Referring to FIG. 4, the fourth embodiment of the present invention comprises a recording medium 601 on which a text-processing program 605 is recorded. The recording medium 601 may be a CD-ROM, magnetic disk, semiconductor memory, or the like, and the embodiment also includes the distribution of the text-processing program through a network. The text-processing program 605 is loaded from the recording medium 601 into a data processing device (computer) 602, and controls the operation of the data processing device 602.

In this embodiment, under the control of the text-processing program 605, the data processing device 602 executes the same processing as that executed by the text input unit 101, temporary model generating unit 103, model parameter initializing unit 104, model parameter estimating unit 105, model selecting unit 107, and text segmentation result output unit 108 in the first, second, or third embodiment, and outputs a segmentation result for each topic with respect to an input text document by referring to a text recording medium 603 and a model parameter estimation result recording medium 604 each of which contains information equivalent to that in a corresponding one of the text storage unit 102 and the estimation result storage unit 106 in the first, second, or third embodiment.

1. A text-processing method characterized by comprising the steps of:
generating a probability model in which information indicating which word of a text document belongs to which topic is made to correspond to a latent variable and each word of the text document is made to correspond to an observable variable;
outputting an initial value of a model parameter which defines the generated probability model;
estimating a model parameter corresponding to a text document as a processing target on the basis of the output initial value of the model parameter and the text document; and
segmenting the text document as the processing target for each topic on the basis of the estimated model parameter.

2. A text-processing method according to claim 1, characterized in that
the step of generating a probability model comprises the step of generating a plurality of probability models,
the step of outputting an initial value of the model parameter comprises the step of outputting an initial value of a model parameter for each of the plurality of probability models,
the step of estimating a model parameter comprises the step of estimating a model parameter for each of the plurality of probability models, and
the method further comprises the step of selecting a probability model, from the plurality of probability models, which is used to perform processing in the step of segmenting the text document, on the basis of the plurality of estimated model parameters.

3. A text-processing method according to claim 1, characterized in that a probability model is a hidden Markov model.

4. A text-processing method according to claim 3, characterized in that the hidden Markov model has a unidirectional structure.

5. A text-processing method according to claim 3, characterized in the hidden Markov model is of a discrete output type.

6. A text-processing method according to claim 1, characterized in that the step of estimating a model parameter comprises the step of estimating a model parameter by using one of maximum likelihood estimation and maximum a posteriori estimation.

7. A text-processing method according to claim 1, characterized in that
the step of outputting an initial value of a model parameter comprises the step of hypothesizing a distribution using the model parameter as a probability variable, and outputting an initial value of a hyper-parameter defining the distribution, and
the step of estimating a model parameter comprises the step of estimating a hyper-parameter corresponding to a text document as a processing target on the basis of the output initial value of the hyper-parameter and the text document.

8. A text-processing method according to claim 7, characterized in that the step of estimating a hyper-parameter comprises the step of estimating a hyper-parameter by using Bayes estimation.

9. A text-processing method according to claim 2, characterized in that the step of selecting a probability model comprises the step of selecting a probability model by using one of an Akaike's information criterion, a minimum description length criterion, and a Bayes posteriori probability.

10. A program for causing a computer to execute the steps of:
generating a probability model in which information indicating which word of a text document belongs to which topic is made to correspond to a latent variable and each word of the text document is made to correspond to an observable variable;
outputting an initial value of a model parameter which defines the generated probability model;
estimating a model parameter corresponding to a text document as a processing target on the basis of the output initial value of the model parameter and the text document; and
segmenting the text document as the processing target for each topic on the basis of the estimated model parameter.

11. A recording medium recording a program for causing a computer to execute the steps of:
generating a probability model in which information indicating which word of a text document belongs to which topic is made to correspond to a latent variable and each word of the text document is made to correspond to an observable variable;
outputting an initial value of a model parameter which defines the generated probability model;
estimating a model parameter corresponding to a text document as a processing target on the basis of the output initial value of the model parameter and the text document; and
segmenting the text document as the processing target for each topic on the basis of the estimated model parameter.

12. A text-processing device characterized by comprising:
temporary model generating means for generating a probability model in which information indicating which word of a text document belongs to which topic is made to correspond to a latent variable and each word of the text document is made to correspond to an observable variable;
model parameter initializing means for outputting an initial value of a model parameter which defines the probability model generated by said temporary model generating means;
model parameter estimating means for estimating a model parameter corresponding to a text document as a processing target on the basis of the initial value of the model parameter output from said model parameter initializing means and the text document; and
text segmentation result output means for segmenting the text document as the processing target for each topic on the basis of the model parameter estimated by said model parameter estimating means.

13. A text-processing device according to claim 12, characterized in that
said temporary model generating means comprises means for generating a plurality of probability models,
said model parameter initializing means comprises means for outputting an initial value of a model parameter for each of the plurality of probability models,
said model parameter estimating means comprises means for estimating a model parameter for each of the plurality of probability models, and
the device further comprises model selecting means for selecting a probability model, from the plurality of probability models, which is used to cause said text segmentation result output means to perform processing associated with the probability model, on the basis of the plurality of model parameters estimated by said model parameter estimating means.

14. A text-processing device according to claim 12, characterized in that a probability model is a hidden Markov model.

15. A text-processing device according to claim 14, characterized in that the hidden Markov model has a unidirectional structure.

16. A text-processing device according to claim 14, characterized in the hidden Markov model is of a discrete output type.

17. A text-processing device according to claim 12, characterized in that said model parameter estimating means comprises means for estimating a model parameter by using one of maximum likelihood estimation and maximum a posteriori estimation.

18. A text-processing device according to claim 12, characterized in that
said model parameter initializing means comprises means for hypothesizing a distribution using the model parameter as a probability variable, and outputting an initial value of a hyper-parameter defining the distribution, and
said model parameter estimating means comprises means for estimating a hyper-parameter corresponding to a text document as a processing target on the basis of the output initial value of the hyper-parameter and the text document.

19. A text-processing device according to claim 18, characterized in that said model parameter estimating means comprises means for estimating a hyper-parameter by using Bayes estimation.

20. A text-processing device according to claim 13, characterized in that said model selecting means comprises means for selecting a probability model by using one of an Akaike's information criterion, a minimum description length criterion, and a Bayes posteriori probability.
